(19) United States
(12) Patent Application Publication
(10) Pub. No.: US 2025/0362454 A1
(43) Pub. Date: Nov. 27, 2025

(54) FUSION SPLICER AND METHOD FOR CONNECTING OPTICAL FIBERS

(71) Applicant: FURUKAWA ELECTRIC CO., LTD., Tokyo (JP)

(72) Inventor: Akio Tanabe, Tokyo (JP)

(21) Appl. No.: 19/294,569

(22) Filed: Aug. 8, 2025

Related U.S. Application Data
(63) Continuation of application No. PCT/JP2024/015704, filed on Apr. 22, 2024.

(30) Foreign Application Priority Data
Apr. 26, 2023 (JP) 2023-072343

(51) Int. Cl. G02B 6/255; G02B 6/02

(52) U.S. Cl. CPC G02B 6/2553; G02B 6/02328; G02B 6/2551; G02B 6/2555

(57) ABSTRACT

A pair of electrodes are disposed in a direction substantially perpendicular to an opposing direction of a pair of optical fibers. The pair of electrodes are disposed so as to oppose each other on a fusion part where tips of the optical fibers are butted and fused together, and a hollow core fiber is positioned between the electrodes. By applying a prescribed voltage across the electrodes, an arc is generated in a straight line connecting the tips of the pair of electrodes. At such time, the axial center connecting the tips of the pair of electrodes is offset relative to the axial center of the hollow core fiber held by an optical fiber holding part. In a state where the arc is formed by applying a voltage across the electrodes, a control unit can rotate a pair of holder mounting parts about the axis of the hollow core fiber and in the same direction at a predetermined speed.

### TECHNICAL FIELD

The present invention relates to a fusion splicer and the like that can fusion splice optical fibers having unique cross-sectional forms, such as hollow core fibers and photonic bandgap fibers.

### BACKGROUND

Fusion splicers are used to connect optical fibers together. A fusion splicer uses a pair of electrodes as a heating source for melting optical fibers. Glass-made optical fibers held by a pair of holders are disposed being butted to each other between the electrodes, and a high voltage is applied across tips of the electrodes so as to generate air discharge for fusing the optical fibers together (Japanese Patent Application Laid-Open Publication No. 2004-184543, for example).

Meanwhile, unique optical fibers such as hollow core fibers and photonic bandgap fibers have been developed in the recent years. For example, a hollow core fiber is a fiber in which light is trapped in air tubes, and, to form such the air tubes, the hollow core fiber has a fine internal structure. Thus, the hollow fiber has a thick glass wall on an outer periphery thereof to ensure strength, and thin glass partition walls inside to form fine air layers.

If such the optical fibers are fused together by using an ordinary method, the internal fine structure would melt and disappear, which may cause light leakage. However, if a heating temperature is reduced excessively, the outer periphery would not melt sufficiently, which decreases the fusion strength and may cause a fracture at a connected part.

### SUMMARY OF THE DISCLOSURE

The present invention was made in view of such problems. It is an object of the present invention to provide a fusion splicer and the like, in which even unique optical fibers, such as hollow core fibers and photonic bandgap fibers, can be efficiently fused together.

To achieve the above object, a first aspect of the present invention is a fusion splicer for connecting optical fibers together. The fusion splicer includes a holder mounting part on which a holder for holding the optical fibers is disposed, and at least a pair of electrodes that are disposed in a direction perpendicular to an axial direction of the optical fibers. In the fusion splicer, an axial center connecting tips of the pair of electrodes is offset relative to an axial center of the optical fibers, and a control unit of the fusion splicer is capable of rotating the holder mounting part or the electrodes about an axis of the optical fibers so that an arrangement of the electrodes in a circumferential direction of the optical fibers is relatively changed.

The control unit may be capable of rotating the holder mounting part about the axis of the optical fibers.

The control unit may be capable of rotating the electrodes around the optical fibers about the axis of the optical fibers.

According to the first aspect of the present invention, since the axial center connecting the tips of the pair of electrodes is offset relative to the axial center of the optical fibers, an arc generated between the electrodes can selectively melt outer periphery portions of the optical fibers instead of center parts thereof. Also, the arrangement of the electrodes in the circumferential direction of the optical fibers is relatively changed, and thus an entire circumference of the outer periphery portions of the optical fibers can be melted to be connected.

By connecting the optical fibers in this way, the outer periphery portions of the optical fibers can be fusion connected with certainty while suppressing heating the center parts. Thus, even unique optical fibers such as hollow core fibers and photonic bandgap fibers can be fusion connected.

For example, by rotating an optical fiber holding part with the electrodes being fixed, the entire circumference of the outer periphery portions of the optical fibers can be sequentially disposed between the electrodes. Thus, the entire circumference of the optical fibers can be fusion connected.

Also, even by rotating the electrodes about the center axis of the optical fibers with the optical fibers being fixed, the arc can be generated to the entire circumference of the outer periphery portions of the optical fibers, and thus the entire circumference of the optical fibers can be fusion connected.

A second aspect of the present invention is a method for connecting optical fibers together using a fusion splicer, which includes a holder mounting part on which a holder for holding the optical fibers is disposed, and at least a pair of electrodes that are disposed in a direction perpendicular to an axial direction of the optical fibers. In the method, an axial center connecting tips of the pair of electrodes is offset relative to an axial center of the optical fibers, and a control unit of the fusion splicer rotates the holder mounting part or the electrodes about an axis of the optical fibers so that an arrangement of the electrodes in a circumferential direction of the optical fibers is relatively changed so that the optical fibers are connected together.

The optical fibers may be hollow core fibers or optical fibers including a core and a cladding on an outer periphery of the core with at least one hollow hole in the cladding. The outer periphery portions of the optical fibers are discharged so as to fuse together the outer periphery portions of the optical fibers, without fusing inside the optical fibers.

The optical fiber may include a plurality of cores and a cladding on an outer periphery of the cores, and the outer periphery portions of the optical fibers are discharged and the optical fibers are fused together such that temperature distribution on the outer periphery portions of the optical fibers during fusion is higher than a temperature inside the optical fibers.

According to the second aspect of the present invention, since the axial center connecting the tips of the pair of electrodes is offset relative to the axial center of the optical fibers, an arc generated between the electrodes can selectively melt the outer periphery portions of the optical fibers instead of center parts thereof. Also, the arrangement of the electrodes in the circumferential direction of the optical fibers is relatively changed, and thus an entire circumference of the outer periphery portions of the optical fibers can be melted to be connected.

Also, for hollow core fibers or optical fibers such as photonic bandgap fibers having hollow holes in the cladding, by fusing the outer periphery portions thereof with certainty, the connection strength can be obtained with certainty, and thin partition walls on inner periphery parts of the optical fibers hardly melt or only melt to a small extent, allowing the optical fibers to be fused together while maintaining air layers.

Also, for multicore fibers having a plurality of cores, for example, the cores in proximity of outer periphery portions, which are more susceptible to core misalignment, can be sufficiently heated to promote diffusion of core dopant. This can enlarge mode field diameters of the cores on an outer periphery side and suppress an influence of the misalignment of the cores.

The present invention can provide a fusion splicer and the like, in which even unique optical fibers, such as hollow core fibers and photonic bandgap fibers, can be efficiently fused together.

### BRIEF DESCRIPTION OF DRAWINGS

FIG. 1 is a perspective view showing a fusion splicer 1.

FIG. 2A is a cross-sectional schematic view of a hollow core fiber.

FIG. 2B is a cross-sectional schematic view of a photonic bandgap fiber.

FIG. 3A is a view showing a step during fusion splicing.

FIG. 3B is a view showing a step during fusion splicing.

FIG. 4 is a view showing another method for fusion splicing.

FIG. 5A is a view showing a step during another fusion splicing.

FIG. 5B is a view showing a step during another fusion splicing.

FIG. 6 is a cross-sectional view of a multicore fiber 31.

### DETAILED DESCRIPTION

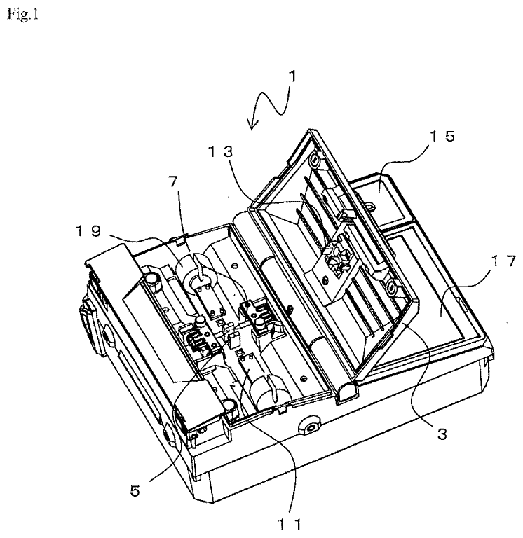

Hereinafter, embodiments of the present invention will be described with reference to the accompanying drawings. FIG. 1 is a perspective view showing a fusion splicer 1. The fusion splicer 1 connects a pair of optical fibers by fusion. Illustrations of structures that are unnecessary for explanation will be omitted in the drawings hereinafter.

As shown in FIG. 1, the fusion splicer 1 has a lid portion 3 that can be opened or closed with respect to a main body. Also, the main body includes a holder mounting part 11 on which a holder for holding an optical fiber is mounted, an optical fiber holding part 5 that holds and positions a tip of the optical fiber, an operation unit 15 that performs alignment operation and fusion operation etc., which will be described below, a display unit 17 that displays various information and images, and so on. The operation unit 15 and the display unit 17 may be integrated by making the display unit 17 a touch panel.

The optical fiber is held in a V groove in the optical fiber holding part 5. Also, a pair of electrodes 7 are disposed in a direction substantially perpendicular to an opposing direction of a pair of the optical fibers (in an axial direction of the optical fibers). An arrangement of the electrodes 7 will be described in detail below.

The lid portion 3 can be opened or closed with respect to the main body. A clamp 13 is provided on a back surface of the lid portion 3, and, when the lid portion 3 is closed, a tip of the clamp 13 is positioned at a part that corresponds to the positions of the optical fibers on the optical fiber holding part 5. That is, the clamp 13 that is provided on the back surface of the lid portion 3 can hold the pair of optical fibers facing each other in the optical fiber holding part 5. When fusion connecting the optical fibers using the fusion splicer 1, firstly, the optical fibers are held by a pair of holders, which are not shown, and the holders are mounted on the holder mounting part 11. The lid portion 3 is closed in such the state, and an arc is generated between the electrodes 7 with tips of the optical fibers being butted to each other.

At this time, the fusion splicer 1 includes a rotation drive unit 19 that rotates the holder mounting part 11. That is, in a state in which the holders holding the optical fibers are disposed on the holder mounting part 11 and the arc is generated between the electrodes 7, the optical fibers can be rotated with a center axis of the optical fibers as a center of rotation. Such the fusion splicer 1 is effective especially for connecting unique optical fibers such as hollow core fibers or photonic bandgap fibers.

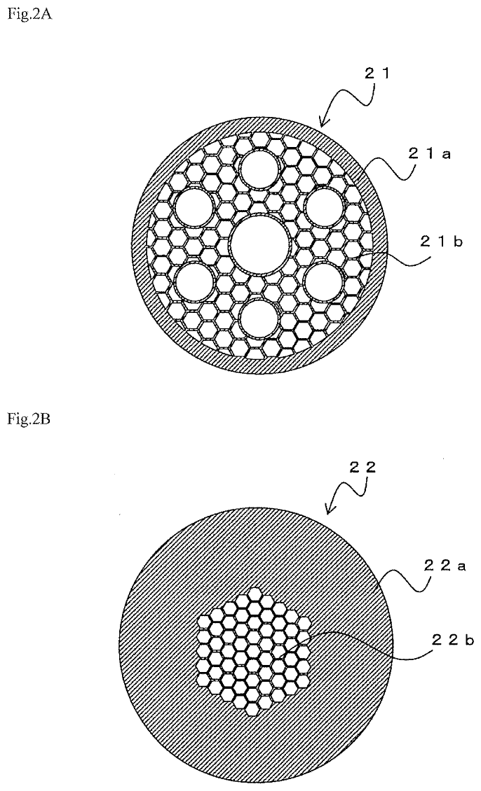

FIG. 2A is a cross-sectional schematic view of a hollow core fiber 21. The hollow core fiber 21 has a thick glass outer periphery portion 21a, and air layers partitioned by thin wall portions 21b are formed inside the outer periphery portion 21a. That is, the hollow core fiber 21 is configured with the thick outer periphery portion 21a and the internal thin wall portions 21b.

FIG. 2B is a cross-sectional schematic view of a photonic bandgap fiber 22. Although having a different cross-sectional shape from the hollow core fiber 21, the photonic bandgap fiber 22 also has thin wall portions 22b that partition the space inside an outer periphery portion 22a (a glass solid portion). Instead of the photonic bandgap fiber 22 shown in the drawing, any optical fibers having a core and a cladding on an outer periphery of the core with at least one hollow hole in the cladding can be applied to the present embodiment.

If the hollow core fibers 21 or the photonic bandgap fibers 22 are to be fused together in the same manner as in ordinary optical fibers, the outer periphery portions 21a and 22a are to be completely melted for fusion connection. In such the case, when the outer periphery portions 21a and 22a are melted, the thin wall portions 21b and 22b may disappear, which may cause light leakage. On the other hand, if heating temperature is reduced to prevent the internal thin wall portions 21b and 22b from melting, the outer periphery portions 21a and 22a would not melt sufficiently, which reduces the fusion strength and may cause a fracture at a connected part.

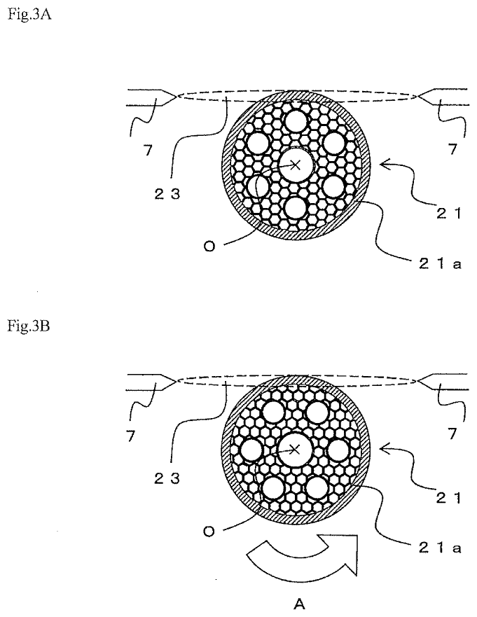

Next, a method for connecting the optical fibers together using the fusion splicer 1 according to the present embodiment will be described in detail. FIG. 3A and FIG. 3B are views showing positional relationships between the electrodes and the hollow core fiber 21 in a state in which an arc 23 is generated between the electrodes.

The pair of electrodes 7 are disposed to face each other at a fusion part where the tips of the optical fibers are butted and fused together, and the hollow core fibers 21 are disposed between the electrodes 7. Although the hollow core fibers 21 are used as optical fibers to be fused together in the description hereafter, the same also applies to the photonic bandgap fibers 22.

As shown in FIG. 3A, applying a prescribed voltage across the electrodes 7 can generate the arc 23 on a straight line connecting the tips of the pair of electrodes 7. At this time, an axial center connecting the tips of the pair of electrodes 7 is offset to an axial center (O in the drawing) of the hollow core fibers 21 held by the optical fiber holder part 5 (the holder disposed on the holder mounting part 11). That is, the arc 23 is formed at a position of the outer periphery portion 21a, instead of at a center of the hollow core fiber 21.

As shown in FIG. 3B, a control unit (not shown) of the fusion splicer 1 is capable of rotating the pair of holder mounting parts 11 about an axis of the hollow core fibers 21 (O in the drawing) at a predetermined speed in one direction (direction A in the drawing) in a state in which the arc 23 is formed by applying the voltage across the electrodes 7. That is, the pair of hollow core fibers 21 with tips thereof being butted to each other rotate in one direction with the center O as a rotational axis.

By rotating the hollow core fibers 21 360° with the arc 23 being formed between the electrodes 7, the outer periphery portion 21a of the hollow core fiber 21 is melted sequentially over an entire circumference so as to be fusion connected.

The fusing operation may be completed by rotating the hollow core fibers 21 by 360°, or by a plurality of revolutions, such as two or three revolutions. In addition, the optical fibers may be rotated not only in one direction but may also be rotated back and forth. For example, the optical fibers may be rotated back and forth with a rotation angle of ±180° with respect to a reference rotational position. Also, the control unit may be capable of setting the number of rotations or a rotation speed according to shapes and dimensions etc. of the optical fibers to be fused together.

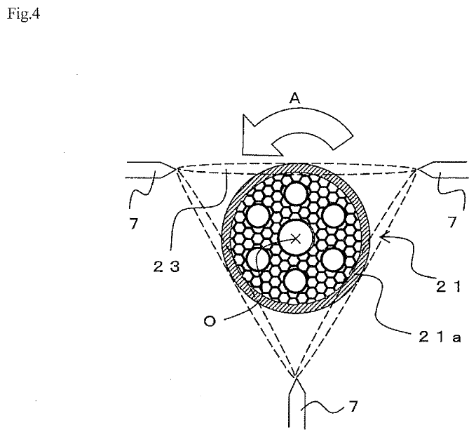

Also, instead of using the pair of electrodes 7, three or more electrodes may be used. FIG. 4 is a view showing a state in which the three electrodes 7 are used. Even in such the case, the straight lines connecting the tips of the adjacent electrodes are disposed being offset to the center O of the hollow core fibers 21. That is, the arc 23 generated between each of the electrodes 7 mainly heats up and melts the outer periphery portions 21a instead of the centers of the hollow core fibers 21.

By rotating the hollow core fibers 21 with the center O of the hollow core fibers 21 as the rotational axis in such the state, the outer periphery portions 21a can be selectively melted over the entire circumference of the hollow core fibers 21 for fusion connection. For example, in such the case, even if the hollow core fibers 21 are rotated only 120° instead of 360°, the outer periphery portions 21a can be melted and fused over the entire circumference.

In such the case, by applying a three-phase AC voltage to the three electrodes 7, it is possible to periodically change the electrodes 7 at which the arc 23 is generated due to difference in the voltage phase. However, in such the case, since frequency is high, a discharge time between each pair of electrodes is several μs to several tens of μs, and thus it actually appears that the arcs are generated between all the adjacent electrodes 7 at all times. Thus, a substantially uniform heating zone is created in a space surrounded by the arcs 23. In such the case, a temperature at the center of the hollow core fiber 21 rises and this may melt and damage the thin wall portions 21b.

For this reason, in such the case, for each combination of the electrodes 7 that generates the arc 23, the control unit may apply a voltage across the electrodes of a predetermined combination for a preset period of time, and, at the same time, may sequentially change the combination of electrodes for each period of time. For example, the control unit may keep discharging across the same electrodes for a period of about 0.1 to 1 second (e.g., several thousand or several tens of thousands of cycles of the high-frequency voltage), change the combination of the electrodes 7 for discharging after the predetermined time has elapsed, and repeat this process for fusion.

In such the case, by combining the rotational movement about the center O of the hollow core fibers 21 as the rotational axis and the position shifting of the arc 23 by the combination of the electrodes 7 for discharging, the entire circumference of the hollow core fibers 21 is heated substantially uniformly so that the hollow core fibers 21 can be fused together with certainty.

Even in such the case, the optical fibers may be rotated back and forth instead of in one direction. For example, a back-and-forth rotation of ±60° from the reference position may be performed for a predetermined combination of the electrodes 7, and then, by performing the similar back-and-forth rotations of ±60° from the reference positions for the other combinations of the electrodes 7, the outer periphery portions 21a can be melted over the entire circumference to be fused.

As above, according to the present embodiment, when the optical fibers to be connected are hollow core fibers 21 or photonic bandgap fibers 22, by heating the outer periphery portions 21a or 22a of the hollow core fibers 21 or the photonic bandgap fibers 22, it is possible to suppress melting of the thin wall portions 21b and 22b at the center. Also, since the entire circumference is not heated uniformly at one time, the outer periphery portions 21a or 22a on a side that is not heated are also cooled down. This can suppress heat from entering into the center with more certainty.

As above, a part of the outer periphery portions of the hollow core fibers 21 or the photonic bandgap fibers 22 are discharged while being rotated so as to fuse together the outer periphery portions 21a or 22a over the entire circumference, and, at the same time, no fusion occurs inside the hollow core fibers 21 or the photonic bandgap fibers 22 such that fusion connection can be performed without melting the thin wall portions 21b or 22b.

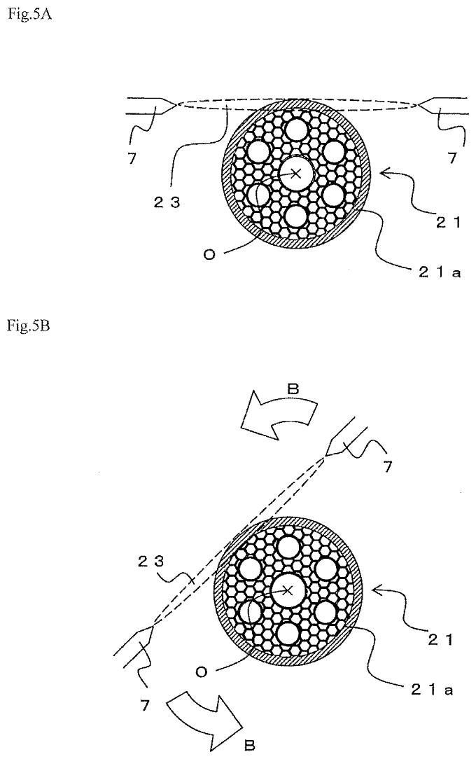

Although the electrodes 7 are fixed and the optical fibers are rotated in the above-mentioned embodiment, the present invention is not limited thereto. FIG. 5A and FIG. 5B are views showing a method in which the control unit rotates the pair of the electrodes 7 around the hollow core fibers 21 with the center axis O of the hollow core fibers 21 as the rotational center (in a direction of an arrow B in the drawing) with the hollow core fibers 21 being fixed.

In the present embodiment, the electrodes 7 are rotated with the center O of the hollow core fibers 21 as the rotational axis, while a distance between the pair of electrodes 7 and a relative arrangement thereof remain the same. That is, the relative motion is the same as in the example shown in FIG. 3A and FIG. 3B, although the optical fibers are fixed and the electrodes 7 are rotated.

As above, the control unit may be capable of rotating at least one of the holder mounting parts 11 or the electrodes 7 about the center axis of the optical fibers so as to relatively change the arrangement of the electrodes 7 in a circumferential direction about the center axis O of the optical fibers.

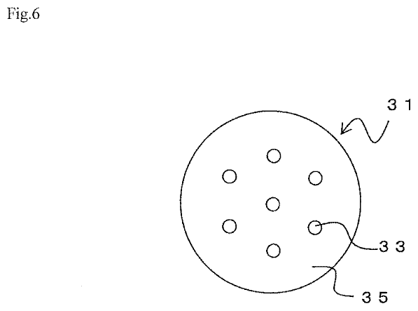

Also, although examples in which hollow core fibers 21 or the photonic bandgap fibers 22 are applied as the optical fibers to be connected have been described in the above-mentioned examples, the present invention is not limited thereto. FIG. 6 is a cross-sectional view of a multicore fiber 31. The multicore fiber 31 includes a plurality of cores 33 and a cladding 35 covering the cores 33. In the illustrated example, the center core 33 is surrounded by the other cores 33 that are disposed at equal intervals.

Unlike the above-mentioned hollow core fibers 21 and the photonic bandgap fibers 22, the cores 33 of the multicore fibers 31 cannot be connected to each other unless the center parts thereof are melted. On the other hand, when aligning the multicore fibers 31, although the center cores 33 are not affected by rotational alignment, the cores 33 on an outer periphery side are affected by misalignment of the rotational alignment and thus are likely to have greater transmission loss than the center cores 33.

By using the fusion splicer 1 for connecting the multicore fibers 31 by fusion to melt the multicore fibers 31 to the center to be fused, such the influence can be reduced. To melt the multicore fibers 31 to the center, there is a method that brings the straight lines connecting the tips of the electrodes closer to the center of the multicore fibers 31 than in a case of the hollow core fibers 21 or the like, by reducing a size of a polygon formed by the tips of the electrodes 7, for example.

In such the case, discharging is performed mainly in proximity of outer periphery portions of the multicore fibers 31, and thus the multicore fibers 31 are fused together such that a temperature distribution on the outer periphery portions of the multicore fibers 31 during fusion is higher than a temperature inside the multicore fibers 31. This can promote diffusion of core dopant of the cores 33 on the outer periphery side. This results in enlargement of mode field diameters of the cores 33 on the outer periphery portions compared to the center cores 33 and suppress an influence of the misalignment of the cores 33 on the outer periphery side. Any optical fibers formed of the cores 33 and the cladding 35 on the outer periphery of the cores 33 and including a plurality of the cores 33 may be applied to the present embodiment even if the optical fibers are not the multicore fibers 31 shown in the drawing.

Other than controlling the rotation of the optical fibers or the electrodes 7, the control unit may also be capable of adjusting intervals between the electrodes depending on types of the optical fibers to be connected, for example. Also, the control unit may be capable of changing the above-mentioned rotation speed of the optical fibers or the electrodes 7 according to the types of the optical fibers.

Also, the control unit may decide to terminate fusing when the predetermined number of rotations is completed, or may decide to terminate fusing based on the predetermined information of the optical fibers. For example, the control unit may use an image of a fusion part or detect leakage of incident light, and may terminate fusing when predetermined conditions are met.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

1. A fusion splicer for connecting optical fibers together, the fusion splicer comprising:
a holder mounting part on which a holder for holding the optical fibers is disposed; and
at least a pair of electrodes that are disposed in a direction perpendicular to an axial direction of the optical fibers, wherein
an axial center connecting tips of the pair of electrodes is offset relative to an axial center of the optical fibers; and
a control unit of the fusion splicer is capable of rotating the holder mounting part or the electrodes about an axis of the optical fibers so that an arrangement of the electrodes in a circumferential direction of the optical fibers is relatively changed.

2. The fusion splicer according to claim 1, wherein the control unit is capable of rotating the holder mounting part about the axis of the optical fibers.

3. The fusion splicer according to claim 1, wherein the control unit is capable of rotating the electrodes around the optical fibers about the axis of the optical fibers.

4. A method for connecting optical fibers together using a fusion splicer, the fusion splicer comprising:
a holder mounting part on which a holder for holding the optical fibers is disposed; and
at least a pair of electrodes that are disposed in a direction perpendicular to an axial direction of the optical fibers, wherein:
an axial center connecting tips of the pair of electrodes is offset relative to an axial center of the optical fibers; and
a control unit of the fusion splicer rotates the holder mounting part or the electrodes about an axis of the optical fibers so that an arrangement of the electrodes in a circumferential direction of the optical fibers is relatively changed so that the optical fibers are connected together.

5. The method for connecting optical fibers according to claim 4, wherein:
the optical fibers are hollow core fibers or optical fibers including a core and a cladding on an outer periphery of the core with at least one hollow hole in the cladding; and
the outer periphery portions of the optical fibers are discharged so as to fuse together the outer periphery portions of the optical fibers, without fusing inside the optical fibers.

6. The method for connecting optical fibers according to claim 4, wherein:
the optical fibers include a plurality of cores and a cladding on an outer periphery of the cores; and
the outer periphery portions of the optical fibers are discharged and the optical fibers are fused together such that temperature distribution on the outer periphery portions of the optical fibers during fusion is higher than a temperature inside the optical fibers.
